(19) United States
(12) Patent Application Publication
(10) Pub. No.: US 2025/0311070 A1
(43) Pub. Date: Oct. 2, 2025

(54) DIMMABLE LED LIGHT FIXTURE WITH ADJUSTABLE CORRELATED COLOR TEMPERATURE CHANGE (CCT) AND BRIGHTNESS PARAMETERS

(71) Applicant: GLOBE ELECTRIC COMPANY INC., Montreal (CA)

(72) Inventors: John Deaton, Bowling Green, KY (US); Jay Allard, Laval (CA); Christopher Presz-Lafreniere, Montreal (CA); Miles William McDonald, Bowling Green, KY (US); Scott Blaise Tylicki, Bowling Green, KY (US); Lorella Zingaro, Montreal (CA)

(21) Appl. No.: 19/096,310

(22) Filed: Mar. 31, 2025

Related U.S. Application Data
(60) Provisional application No. 63/572,795, filed on Apr. 1, 2024.

(51) Int. Cl. H05B 45/10; H05B 45/20; H05B 45/31; H05B 45/37; H05B 47/175; H05B 47/19

(52) U.S. Cl. CPC H05B 45/10; H05B 45/20; H05B 45/31; H05B 47/19; H05B 47/1965; H05B 45/37

(57) ABSTRACT

Components and circuitry for controlling a bank of LEDs based on a dimmer switch and a CCT controller to maintain a brightness level while changing the color temperature of an emitted composite light, to adjust a brightness level simultaneous to changing the color temperature of the emitted composite light, and to drive the bank of LEDs to generate the composite light based on selection of one or more CCT setpoints of the CCT controller.

### TECHNICAL FIELD

Embodiments herein relate to one or more of LED light fixtures and circuitry for controlling LED light fixtures, including controlling of LED brightness and color correlated temperature (CCT) corresponding to a setting of one or more of a dimmer switch and a CCT switch.

### BACKGROUND

LED lighting is popular because of energy efficiency, long life, and a reduced pollution aspects relative to alternative lighting options (e.g., CFL, incandescent, etc.). Triac dimmers may be used in conjunction with LED banks to control CCT and brightness of LEDs.

By controlling a dimmer switch connected to an LED lamp load, connected LED lamps can achieve smooth and linear adjustment of brightness. However, due to the LED's luminescent properties, the color temperature of LED lamps will not change with a change in driver current. In order to achieve a change in color temperature similar to an incandescent lamp, LED technology uses two or more color temperature variations of LED chips, generally 3000 Kelvin temperature and 2000 Kelvin temperature chips. The current ratio mix is adjusted for the different LED chips allowing the light fixture to achieve this function. Using this advancement in technology, dimmers can adjust the brightness output and color temperature concurrently.

Color temperature can be described in terms of the color emitted by a light fixture with a spectrum from bright light, such as daylight, to warm soothing amber light such as at dusk. LED light sources do not exhibit visible spectrum radiation at all wave lengths of the spectrum and are measured according to a correlated color temperature (CCT) scale. It would be desirable to be able to operate LED light sources to produce variable color from bright white to amber tone while maintaining bright luminosity. Such would create a light environment which is warm, cozy and relaxing such as is desirable during dinning or working late over a desk top or in front of a computer. It is well known that bright light stimulates the senses of a person and can be disruptive to a person's health particularly when exposed to bright light at night time creating the effect of jet lag, poor sleep and lack of energy during the day. It could also lead to other adverse conditions such as disruption of vital hormone production.

The present disclosure therefore provides for a dimmable LED light fixture, in the form of lamps or luminaires, and method of operation capable of overcoming the above mentioned disadvantages of LED lighting and thus providing an LED light environment wherein the Kelvin temperature of the LED light source is down to about 3000 to 2000 Kelvin while maintaining brightness.

### SUMMARY

It is a feature of the present disclosure to provide a dimmable LED light fixture, in the form of lamps, luminaires, and circuitry, as well as a method of operation, which is capable of operating a bank of LEDs to maintain a brightness level while changing the color temperature of the light spectrum, change a brightness level and color temperature simultaneously, and identify selection of one or more setpoint corresponding maintaining or adjusting the brightness and color temperature features based on position of a dimmer switch and CCT controller.

For example, in some implementations, it may be desirable to provide a dimming switch which allows the dimming of the LEDs by virtue of maintaining brightness of the LED output but reducing the CCT of the light, down to a determined lower dimming brightness, for example 90% of the maximum LED output brightness. While a dimming switch is moved downward to “dim” the light output below this set point, the brightness is may be reduced while also coordinating either reduction of the CCT or continuation of the CCT until a lower brightness level is reached. At a predetermined dimming setting, say 10%, continued reduction of the dimming setting causes further reduction the brightness of the LED output while also reduction of the CCT to a lower CCT limit. In the example provided, the dimming causes initial reduction in the CCT until a predetermined CCT is reached while maintaining brightness. At this point, continued reduction in “dimming” causes dimming of brightness/intensity output of the LEDs while maintaining the reduced predetermined CCT. Further action of dimming reduction may maintain the predetermined CCT while reducing the intensity/brightness of the LED output. At a lowest dimming setting, a lower limit reduced CCT may be achieved in combination with reduction of brightness/intensity to a lower limit. For example, once a dimming level of 10% is reached, further reduction of dimming causes additional reduction of the CCT of the LED output to a predetermined lowest threshold. For example, in above scenario, initial reduction of brightness from 100% initially reduces the CCT from a high CCT level of 5000K, for example, Once the CCT is reduced, by action of the dimming switch, to 3000K, the CCT is maintained while the brightness if reduced. Continued reduction of the brightness may cause associated continuation of the determined CCT (say 3000K) or may result in a slow reduction of the CCT as the dimming level is reduced downward to an additional setpoint, say 10%. Once 10% dimming is reached, the CCT may be reduced down to 2000K and maintained.

According to aspects of the above features, the present disclosure provides a dimmable LED light fixture, in the form of lamps and/or luminaires, and control circuitry for maintaining and adjusting brightness relative to CCT. The control circuit is operably connected to a bank of LEDs and may include at least a dimmer switch and a CCT controller. The dimmer switch includes a range of dimming settings, and a dimmer input signal is provided to the control circuit corresponding to a selected dimming setting. The CCT controller includes one or more CCT setpoint switches that corresponds to a high CCT setting, a low CCT setting, and an inflection CCT setting associated with a range of dimming settings of a dimmer switch, in which movement (within that range) adjusts both brightness and CCT, and the CCT controller provides a controller input signal to the control circuit corresponding to a selected CCT setpoint. The bank of LEDs may include subsets of a plurality of LEDs that correspond to distinct CCTs, and composite light having a brightness and composite CCT may be emitted based on the input signal corresponding to the dimming setting and the other input corresponding to the CCT controller setting. The composite light may be produced by mixing the distinct CCTs corresponding to the subsets of the plurality of LEDs.

In some implementations, an LED lamp or bank of LEDs may be configured for operation with a first input signal received from a dimmer switch and a second input signal received from a correlated color temperature (CCT) controller. In some implementations, the dimmer switch may have a dimmable range of a first portion, a second portion, and a third portion. In some implementations, the second input signal may be associated with a high CCT setpoint, low CCT setpoint, and an inflection CCT setpoint. In some implementations, the first input signal may correspond to a setting of the dimmer switch and the second input signal may correspond to a setting of the CCT controller. In some implementations, the LED lamp may include a first LED light source having a first CCT, a second LED light source having a second CCT different from the first CCT, and a third LED light source having a third CCT different from the first CCT and the second CCT. In some implementations, the first light emitted from the first LED light source, second light emitted from the second LED light source, and third light emitted from the third LED lights source, may be combined during operation to produce a composite light having a brightness and a composite CCT.

In some implementations, control circuitry may be coupled with the first, second, and third LED light sources. In some implementations, control circuitry may be configured to couple with the first input signal and the second input signal and drive the first, second, and third LED light sources based thereon the first input signal and the second input signal. In some implementations, the control circuitry may be further configured to maintain the brightness of the composite light while changing the composite CCT from the high CCT setpoint to the inflection CCT setpoint responsive to changes of the setting of the dimmer switch that are within the first portion of the dimmable range until the composite CCT reaches the inflection CCT setpoint. In some implementations, the control circuitry may be further configured to change the brightness of the composite light while also changing the composite CCT responsive to changes of the setting of the dimmer switch that are within the second portion of the dimmable range until the composite CCT reaches the low CCT setpoint. In some implementations, the control circuitry may be further configured to change the brightness of the composite light while maintaining the composite CCT at the low CCT setpoint responsive to changes of the setting of the dimmer switch that are within a third portion of the dimmable range.

In some implementations, the setting of the CCT controller corresponds with an adjustable switch of the CCT controller. In some implementations, the setting of the dimmer switch corresponds with adjustment of user actuatable dimmer switch or slider. In some implementations, each of the high CCT setpoint and the low CCT setpoint are independently adjustable using the adjustable switch or one or more other adjustable switches of the CCT controller. In some implementations, one or more of the control circuitry, the CCT controller, and the dimmer switch are controlled by a remote device. In some implementations, the remote device comprises a phone, computer, smart device, or third party remote. In some implementations, one or more of the control circuitry, the CCT controller, and the dimmer switch are controlled by an application executing on the remote device. In some implementations, the dimmer switch is a triac dimmer switch.

In some implementations, an LED lamp may be configured for operation with a first input signal received from a dimmer switch and a second input signal received from a correlated color temperature (CCT) controller. In some implementations, the first input signal corresponds to a dimming setting of the dimmer switch. In some implementations, the dimming setting includes a plurality of ranges. In some implementations, the second input signal corresponds to CCT controller settings. In some implementations, the CCT controller settings are associated with a high CCT setpoint, a low CCT setpoint, and an inflection CCT setpoint. In some implementations, the high CCT setpoint and the low CCT setpoint are independently adjustable. In some implementations, the inflection CCT setpoint is defined by the high CCT setpoint and the low CCT setpoint. In some implementations, the LED lamp includes LED light sources having distinct CCT ranges that emit light during operation to produce a composite light having a brightness and a composite CCT. In some implementations, the LED lamp includes control circuitry and drivers coupled with the LED light sources and configured to couple the first input signal and the second input signal and drive the LED light sources based thereon. In some implementations, the control circuitry is further configured to maintain the brightness of the composite light while changing the composite CCT from the high CCT to the inflection CCT responsive to changes of the setting of the dimmer switch that are within a first range until the composite CCT reaches the inflection CCT. In some implementations, the control circuitry is configured to change the brightness of the composite light while also changing the composite CCT responsive to changes of the setting of the dimmer switch that are within a second range until the composite CCT reaches the low CCT. In some implementations, the control circuitry is configured to change the brightness of the composite light while maintaining the composite CCT at the low CCT responsive to changes of the setting of the dimmer switch that are within a third range.

In some implementations, an LED lamp may be configured for operation with a first input signal corresponding to a dimming setting of a dimmer switch and a second input signal corresponding to a CCT controller setting. In some implementations, the CCT controller setting is associated with a high CCT setpoint, a low CCT setpoint, and an inflection CCT setpoint. In some implementations, one or more of the high CCT setpoint, the low CCT setpoint, and the inflection CCT setpoint are adjustable by one or more switches of the CCT controller. In some implementations, the LED lamp includes a bank of LEDs emitting light during operation to produce a composite light having a brightness and a composite CCT within a range of CCT. In some implementations, the range of CCT is defined by the high CCT setpoint and the low CCT setpoint. In some implementations, the LED lamp includes control circuitry coupled with the bank of LEDs. In some implementations, the control circuitry is configured to couple the first and second input signal and drive the bank of LEDs at the brightness and the composite CCT based on the first input signal and the second input signal. In some implementations, the control circuitry is configured to adjust both brightness and composite CCT within the range of CCT based on the dimming setting corresponding to the inflection point CCT setting.

### BRIEF DESCRIPTION OF THE DRAWINGS

FIG. 1 is a perspective view representative of a luminaire housing, CCT controller, and junction box, and circuitry connecting each component.

FIG. 2 depicts a front and side view of a CCT controller, including a CCT setpoint switch and a dual bright On/Off Switch.

FIG. 3 depicts a front view of a dimmer switch including a dimmer On/Off switch, and a table indicating dimming portions corresponding to operation of the dimmer switch, wherein the dimming portions being associated with a respective brightness and CCT.

FIG. 4 depicts a front view of a CCT controller with two separate CCT setpoint switches, each corresponding to a separate CCT setpoint, and a Dual bright On/Off switch.

FIG. 5 depicts a front view of a CCT controller with two separate CCT setpoint switches, each corresponding to the same setpoint.

FIG. 6 depicts a front view of a CCT controller with a CCT setpoint switch and a Dual bright On/Off switch.

FIG. 7 depicts a table with examples of setpoints that a CCT setpoint switch could be set to correspond with, and a high CCT, low CCT, and inflection point associated with the setpoints.

FIG. 8 schematically depicts examples of control circuitry used to adjust CCT and brightness based on input from a dimmer switch and a CCT controller.

FIG. 9 schematically depicts examples of power circuitry used to provide power to components described herein.

FIG. 10 depicts a block diagram of features of an example control circuit, including a dimmer switch and CCT controller capable of providing input to an LED bank, wherein subsets of LEDs of the LED bank each correspond to a distinct CCT that could mix to create a composite light.

FIG. 11 depicts frontward and downward facing views on an example LED luminaire including LEDs that could be operated according to disclosure herein.

FIG. 12 schematically illustrates an example computer architecture on which selected aspects of the present disclosure may be implemented.

### DETAILED DESCRIPTION

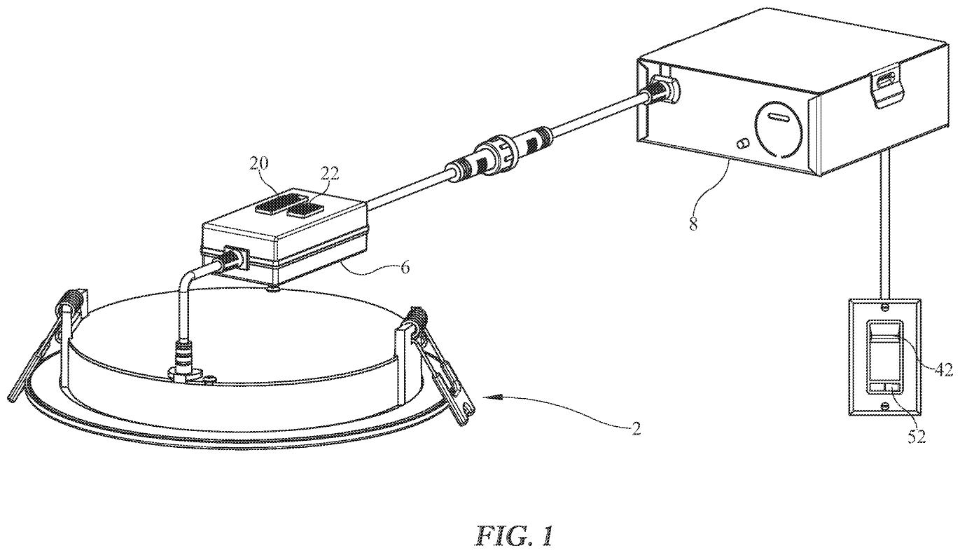

Referring now to the figures and more specifically to FIG. 1, there is shown an example luminaire 2 connected to a CCT controller 6 which is connected to junction box 8 that is also connected to a dimmer switch 4. Luminaire 2 is merely an example of a lighting fixture which can be operated according to disclosure herein. Luminaire 2 includes a light source, such as an LED, incandescent source, etc., which can be operated to emit light at one or more brightnesses and colors (e.g., CCT).

CCT of LEDs of luminaire 2 may be selected, mixed, and adjusted based on input provided by CCT controller 6 and dimmer switch 4. CCT controller 6 includes at least two switches, including a CCT setpoint switch 20 and a dual bright On/Off switch 22.

“Dual bright” refers to functions discussed herein, e.g., including but not limited to adjustment and/or maintenance of CCT relative to brightness of a composite light emitted by LEDs based on settings of CCT controller 6 and dimmer switch 4. Using FIG. 1 as an example, in some implementations, CCT of LEDs in luminaire 2 may only be adjusted in response to dimmer switch 4 being set to a particular dimming setting 42, and may only be adjusted if the dual bright On/Off switch 22 is “On”. Otherwise, for example if dual bright On/Off switch is turned “Off”, dimmer switch 4 may function traditionally, e.g., only adjusting brightness in response to adjustment of the dimmer switch 4. In some implementations, CCT controller 6 may control a static CCT (e.g. a single CCT that isn't adjusted responsive to dimmer switch 4 adjustment), even if dual bright switch 22 is “Off”. For example, while a particular setpoint 20 value of e.g., 5000k, may be associated with a dynamic CCT (corresponding to dimming setting 42) and one or more of a high CCT, low CCT, and inflection point while dual bright switch 22 is “On”, the particular setpoint value of 5000k may be associated with a static CCT of 5000k at all ranges of dimming setting 42 while dual bright switch 22 is “Off”.

Dimmer switch 4 may include one or more dimming settings 42 and a dimmer On/Off switch 52. In some implementations, dimmer switch 4 may be a triac dimmer switch, a potentiometer, sampling and/or modification of modulation, constant current reduction or other techniques. For example, in some implementations, the dimmer switch may be a standard dimmer slide, such as a Triac dimmer, the AC voltage waveform is modulated to reduce the amount of power delivered to the light source. In other forms of dimming implementations, a DC voltage may be sent as a signal to an electronic controller which modifies the light output based upon the delivered signal. In still other forms, modulation techniques may be further utilized in known PWM implementations. Still further implementations may combine both analog devices with digital devices and/or utilize complete digital signaling between the user input dimmer switch and the controllers/drivers for the LEDs.

As depicted in FIG. 1, dimming setting 42 may be adjustable using a variable sliding adjustment mechanism. However, dimmer switch 4 as depicted in FIG. 1 is only an example, and dimmer switches of alternative structural and electronic designs may be used. In some embodiments, dimmer switch 4 may include a dimmer On/Off switch 52, which impacts whether or not power is supplied to luminaire 2. In some implementations, dimmer On/Off switch 52 may also impact whether or not power is supplied to CCT controller 6. In some implementations, fully adjusting a dimming setting to a maximum or minimum point in a range of dimming settings may result in LEDs of luminaire 2 not receiving power. For example, the lowest setting possible in a variable range of dimming settings 52 may essentially correspond to an “off” setting. Dimmer switch 4 being “off” may correspond to dimmer switch 4 being in an inactive state, and dimmer 4 switch being “on” corresponds to dimmer switch 4 being in an active state. A structure of a dimmer switch 4 may determine whether dimmer switch 4 has one or more active or inactive states. There may be a plurality of active state ranges associated with dimmer switch 4 being “on”.

CCT controller 6 may include at least two switches, including a CCT setpoint switch 20 and a dual bright On/Off Switch 22. As discussed above, CCT setpoint switch 20 may correspond with one or more setpoints, which may be associated with static CCT values if dual bright On/Off Switch 22 is “Off” and which may be associated with dynamic CCT values if dual bright On/Off switch 22 is “On”. If dual bright On/Off switch is “On” these dynamic CCT values may correspond with one or more parameters, including high CCT, low CCT, inflection points, combinations of brightness and CCT, ratios of adjustment of brightness and CCT, and corresponding ranges of dimming settings, as non-limiting examples. If dual bright On/Off switch 22 is “Off” these dynamic CCT values may not correspond with one or more parameters.

Luminaire 2, dimmer switch 4, and CCT controller 6 may be electronically coupled with a control circuit and power circuit. Dimmer switch 4 may provide a dimmer input signal to the control circuit and CCT controller 6 may provide a CCT controller input signal to the control circuit, and the control circuit can drive LEDs of luminaire 2 based on the dimmer input signal and the CCT controller input signal, e.g., controlling both brightness and CCT of the LEDs. For example, the control circuit can drive LEDs of luminaire 2 at a particular brightness and CCT corresponding to a given dimming setting 42 based on the dimmer and CCT controller input signals from the dimmer switch 4 and CCT controller 6. Moreover, the second input signal from CCT controller 6 can cause one or more ranges, of the dimming setting 42, to correspond with a particular brightness, and a particular CCT, and a particular ratio of adjustment of the particular brightness and the particular CCT. Accordingly, one or more ranges of dimmer switch 4 may correspond with one or more CCT ranges. CCT controller 6 may take form in a variety of structures, some examples of which are illustrated and discussed subsequently.

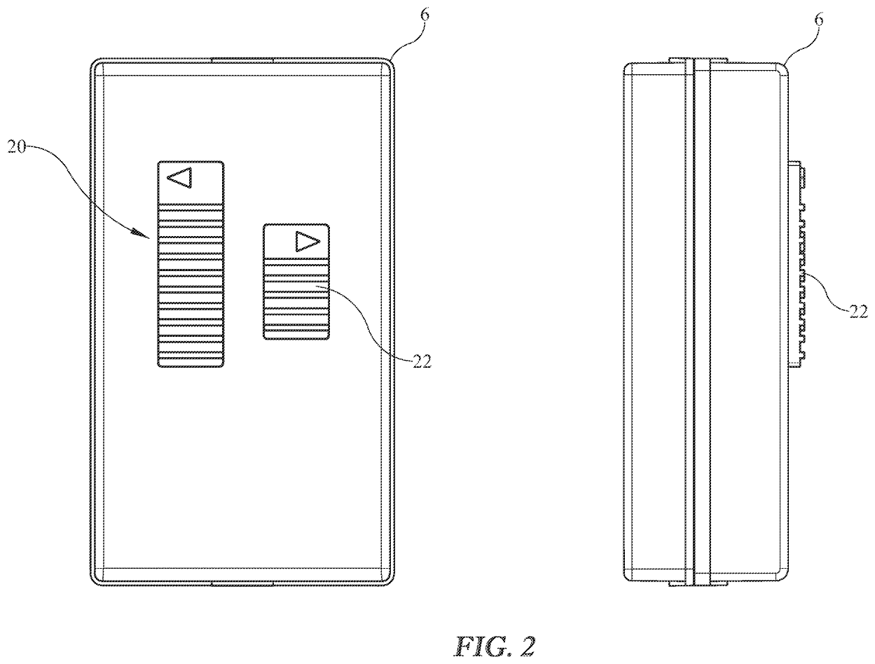

FIG. 2 depicts front and side views of an example CCT controller 6. As discussed above, CCT controller 6 may include a CCT setpoint switch 20 and a dual bright On/Off switch 22. The CCT setpoint switch 20 may be capable of selecting one or more setpoints and may include a graphic indicating which setpoint of the plurality of setpoints in selected. The setpoints may correspond with one or more of a high CCT, low CCT, and inflection point discussed above. As illustrated in FIG. 2, this graphic may be an arrow. Similarly, the dual bright On/Off switch 22 may include a graphic, such as an arrow, to indicate whether an “On” or “Off” setting is currently selected. It is appreciated that alternative and/or additional graphics may be associated with CCT controller 6 to aid in distinguishing which setpoint is selected and whether dual bright is turned On or Off.

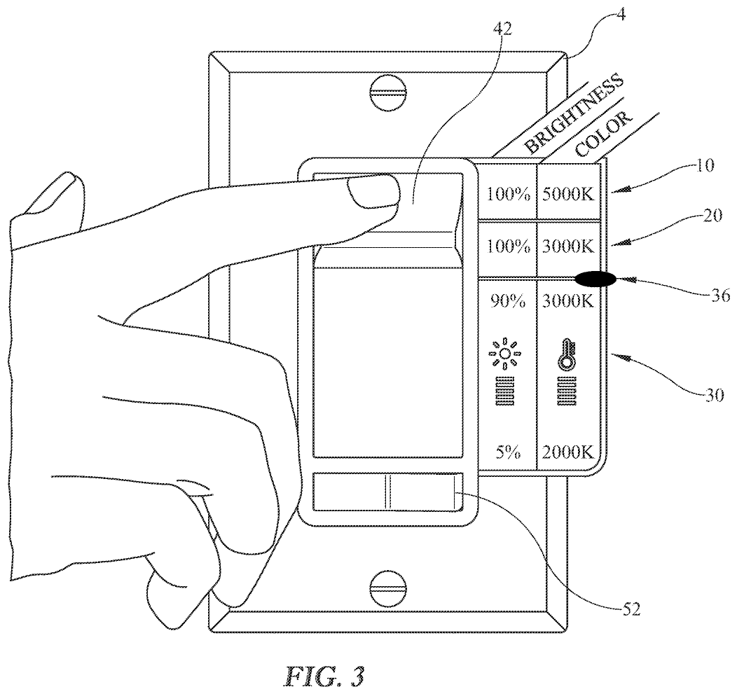

FIG. 3 is a front facing view of dimmer switch 4. Dimmer switch 4 may include a dimming setting 42 and a dimmer On/Off setting 52. Additionally, FIG. 3 illustrates ranges of the dimming setting which may correspond with example brightness and CCT combinations that LEDs of luminaire 2 may be driven. For example, a first range 10 of dimmer setting 42 may correspond with a brightness intensity of 100% at 5000k CCT, a second range 20 of dimmer setting 42 may correspond with a brightness intensity of 100% at 3000K CCT, and a third range 30 of dimmer setting 42 may correspond with a brightness that is adjustable from 90% down to 5%, and a CCT that is adjustable from 3000k to 2000k.

Using FIG. 3 as an example, dimming setting 42 being within the first range 10 would correspond with LEDs being driven at 100% brightness at a 5000k CCT. Adjustment of dimming setting 42 downward within the second range 20 would correspond with LEDs being driven at 100% brightness and at a reduced CCT at 3000k. If dimming setting 42 is adjusted to be back in the first range 10, then LEDs would revert back to being driven at 100% brightness at 5000k CCT, e.g., the brightness and CCT corresponding to the first range 10. However, if dimming setting 42 is adjusted from the second portion 20 past inflection point 36 to a third portion 30, then LEDs would be driven at CCTs and brightnesses corresponding to third portion 30. For example, LEDs driven corresponding to third range 30 would be driven at 90% brightness at 3000k CCT to 5% brightness at 2000k CCT, wherein brightness and CCT within the range of third range 30 would correspond to adjustment of dimming setting 42. Dimming setting 42 being placed adjacent to inflection point 36 would result in a brightness and CCT of approximately 90% at 3000k, dimmer switch setting 42 being placed equidistant from inflection point 36 and a minimum dimming setting would result in a brightness and CCT of approximately 45% at 2500k, and dimmer switch setting 42 being placed at near a minimum dimming setting would result in a brightness and CCT of approximately 5% at 2000k, etc. Accordingly, in some implementations, inflection points may correspond to a CCT at which a dimmer starts adjusting brightness.

The values that a range of dimming setting 42 encompasses, the number of dimming setting ranges, the brightness intensity associated with a given range of dimming setting 42, and one or more CCT values associated with a given range of dimming setting 42 may correspond to static preset parameters in some implementations, and may correspond to adjustable parameters in some implementations. Moreover, proportional adjustment of CCT and brightness may be static in some implementations and adjustable in some implementations, e.g., such that a ratio of CCT to brightness adjustment may be adjusted to e.g., 0:1 brightness-to-CCT adjustment, 1:0 brightness-to-CCT adjustment, 1:1 brightness-to-CCT adjustment to 2:1 brightness-to-CCT adjustment, etc. In some implementations, these parameters may be adjustable by a user.

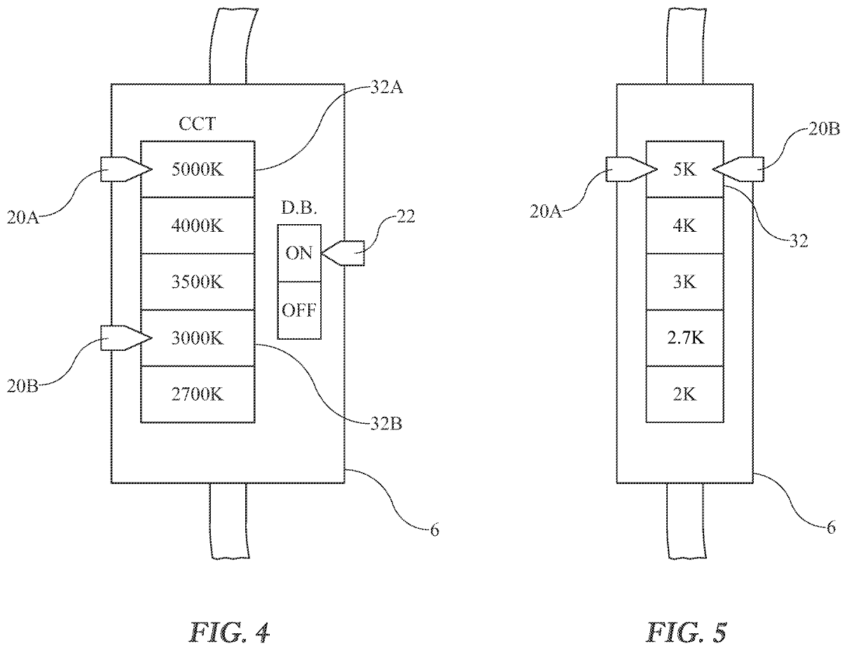

FIGS. 4 and 5 depict embodiments of CCT controller 6 featuring a plurality of CCT setpoint switches 20A and 20B. As discussed herein, a CCT controller may include a one or more CCT setpoint switches, which may each offer distinct combinations of brightness and CCT, and which may each offer distinct ratios of adjustment of brightness and CCT, and which may further offer distinct ranges of dimming settings corresponding to these distinct ratios and combinations, as non-limiting examples of possible distinctions between parameters associated with given setpoint switches. In some implementations, parameters including combinations of brightness and CCT, ratios of adjustment of brightness and CCT, and ranges of dimming settings corresponding to them may overlap across one or more setpoint switches or be completely different.

FIG. 4 depicts a CCT controller 6 featuring two CCT controllers 20A and 20B on the left-hand side. The two CCT setpoint switches include a first CCT setpoint switch 20A indicating selection of a first CCT setpoint 32A of 5000k, and a second CCT setpoint switch 20B indicating selection of a second CCT setpoint 32B of 3000k. FIG. 4 also depicts CCT controller 6 including a dual bright On/Off switch, which as discussed previously, may be used to enable or disable adjustment of CCT responsive to dimmer switch movement.

Using FIG. 4 as an example, in some implementations CCT setpoint switch 20A corresponding to CCT setpoint 32A of 5000k would result in a maximum “high” CCT of 5000k being associated with a composite light capable of being emitted by LEDs. In some implementations, CCT setpoint switch 20B corresponding to CCT setpoint 32B of 3000k would result in a minimum “low” CCT being associated with a composite light capable of being emitted by LEDs. Accordingly, FIG. 4 depicts an example in which CCT may be adjusted between 5000k and 3000k proportional to adjustment of a dimmer switch. Moreover, selected CCT setpoints 32A/32B, and a distance between CCT setpoint switches 20A and 20B, can effect one or more inflection points, e.g., points at which brightness adjust corresponding to CCT. For example, if an inflection point corresponds to setpoint switches 20A and 20B and/or setpoints of 5000k and 3000k, the inflection point may be around 3500k, as opposed to 3000k if the setpoints were 4000k and 2700k. This is a non-limiting example however, as other parameters discussed herein may be impacted based on selected setpoints and adjustments of setpoint switches. Moreover, in some implementations, setpoints and/or setpoint switches do not necessarily always correspond with an inflection point. In some implementations, setpoints and/or setpoint switches may correspond with only one or more other parameters, e.g., a high CCT and/or low CCT, etc. Parameters discussed herein may be customizable and may be associated with various components discussed herein.

In some implementations CCT setpoint switches 20A and 20B may be capable of corresponding to the same setpoint. In some implementations, parameters associated with setpoint switches 20A and 20B may be mixed in the event of overlap. In some implementations, special parameters (e.g., addition, removal, and/or modification of one or more parameters) will be used in the event of overlap of setpoint switches on a setpoint. In some implementations, overlap of setpoint switches may result in a single setpoint, e.g., 32A or 32B, being selected. In some implementations, a priority between overlapping setpoint switches 20A and 20B may be determined (e.g., based on which setpoint switch corresponds with a given setpoint first), and the CCT controller input signal from CCT controller 6 may correspond with the priority.

Using FIG. 4 as an example, in some implementations, if CCT setpoint switch 20A corresponds with CCT setpoint 32A at a first moment and CCT setpoint switch 20B corresponds with CCT setpoint 32A at a second moment, then if parameters (e.g., a high CCT) are associated with CCT setpoint switch 20A, they may be operative by priority. Alternatively, if CCT setpoint switch 20B corresponds with CCT setpoint 32B at a first moment and CCT setpoint switch 20A corresponds with CCT setpoint 32B at a second moment, then if parameters (e.g., a low CCT) are associated with CCT setpoint switch 20B, they may be operative by priority.

In some implementations, regardless of which CCT setpoint switch 20A or 20B is associated with a particular setpoint first, e.g., 32A, one or more parameters associated with each CCT setpoint switch 20A or 20B will be mixed on the basis of the two setpoints 32A and 32B corresponding to the same setpoint. In some implementations, if setpoint switches 20A and 20B correspond to the same setpoint, e.g., 32A, special parameters may apply, such as removing a high CCT associated with e.g., setpoint switch 20A and/or a low CCT associated with e.g., setpoint switch 20B. In some implementations, a plurality of setpoint switches corresponding to a single setpoint may result in dual bright being turned “Off”, and LEDs emitting light at a static CCT corresponding to a single setpoint. Parameters may also or alternatively be associated with one or more CCT setpoints themselves (as opposed to CCT setpoint switches), and in some implementations, a CCT setpoint will be associated with special parameters operative in the event that a plurality of CCT setpoint switches correspond with the CCT setpoint.

FIG. 5 depicts an embodiment of CCT controller 6 featuring two CCT setpoint switches 20A and 20B, on opposing sides. CCT setpoint switch 20A may correspond to a first set of parameters, and CCT setpoint switch 20B may correspond to a second set of parameters. The parameters may include maximum CCTs, minimum CCTs, inflection points, adjustment ratios, etc. Moreover, while CCT setpoint switch 20A and 20B may correspond to different parameters, a priority between setpoint switch 20A and 20B may also be set e.g., based on which setpoint switch of 20A and 20B was set at a value first, based on parameters associated with each respective setpoint switch, etc. Further parameters associated with a setpoint switch 20A or 20B may be rendered inactive or modified based on placement of setpoint switch 20A and/or setpoint switch 20B. For example, if setpoint switch 20A is associated with a high CCT and setpoint switch 20B is associated with a low CCT, and setpoint switch 20A corresponds to a setpoint of 3000k while setpoint switch 20B corresponds with a setpoint of 4000k, then a low CCT parameter associated with setpoint 20B may be rendered inactive, or the low CCT parameter associated with setpoint 20B may be set to a different default setting.

In some implementations, if a dual bright On/Off switch is not included in a controller 6, one or more other components or parameters will enable or disable dual bright functionality. In some implementations, if a dual bright On/Off switch is not included in a controller 6 (such as depicted in FIG. 5), dual bright functionality may be enabled or disabled by default. Using FIG. 5 as an example, dual bright functionality may be enabled by default, or may to be enabled by adjustment of CCT setpoint switches 20A and 20B, e.g., by bringing them into and out of an overlapping setpoint within a period of time, or some other pattern of adjustment. As another example, dual bright functionality may be turned on by adjusting settings of a dimmer switch. Still yet, dual bright functionality may be operated using an application and/or remote device.

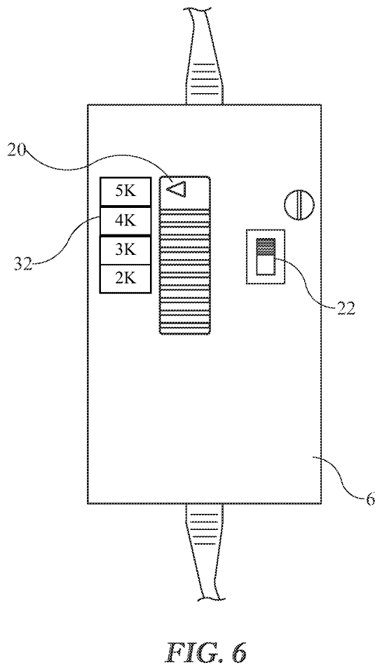

FIG. 6 depicts an embodiment of CCT controller 6 featuring single CCT setpoint switch 20 having a graphical indication of selectable setpoints 32. Using FIG. 6 as an example, the CCT setpoint switch 20 indicates that a CCT setpoint 32 of 2700k is currently selected, while other potential setpoints 32 are available. In some implementations, setpoint settings may have graphical indications, such as descriptions, graphics, colors, etc., to distinguish respective parameters associated therewith. FIG. 6 further depicts a dual bright On/Off switch next to the CCT setpoint switch.

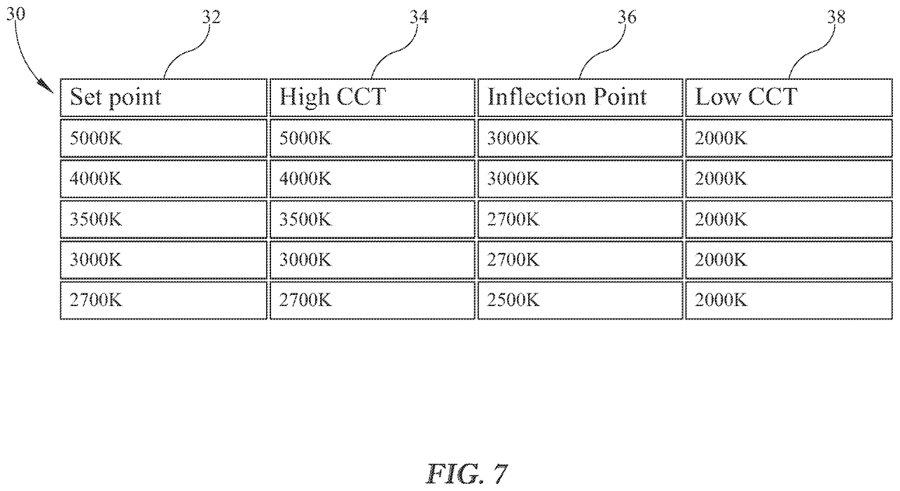

FIG. 7 depicts a table of example setpoints corresponding to high CCTs, inflection points, and low CCTs. As discussed herein, setpoint 32 may correspond to the placement of a physical CCT setpoint switch. Using FIG. 7 as an example, a plurality of setpoints 32 may be selectable, including 5000k, 4000k, 3500k, 3000k, and 2700k. The setpoints 32 depicted in FIG. 7 directly equate to high CCTs depicted therein. The setpoints 32 depicted in FIG. 7 further correspond with a given inflection point 36 and a low CCT 38. As discussed herein, some embodiments of a CCT controller may feature one or more CCT setpoint switches.

FIG. 7 may correspond to a CCT controller including only one CCT setpoint switch, such that a setpoint selected by the single CCT setpoint switch controls parameters including all three of a high CCT, an inflection point, and a low CCT. For example, if the single setpoint switch corresponds with a setpoint associated with 5000k, then a high CCT of 5000k, a inflection point at 3000k, and a low CCT at 2000k will be implemented.

FIG. 7 may also correspond to a CCT controller including a plurality of CCT setpoint switches, such that a first setpoint switch may correspond with a selected setpoint (e.g., 5000k), but a second setpoint switch may correspond with one or more of the high CCT, inflection point, and low CCT, such that the second setpoint switch can modify one or more of those parameters relative to the table depicted in FIG. 7.

FIG. 7 depicts only an example table, and in some implementations values associated with parameters, e.g., high CCT, low CCT, inflection points, etc., may vary. Further, in some implementations, values associated with parameters may be adjustable, e.g., by a user, by manufacturer, etc. Adjustment of parameters may occur via circuit design, programming, interaction with components (CCT controllers, dimmers, remote devices) discussed herein, etc.

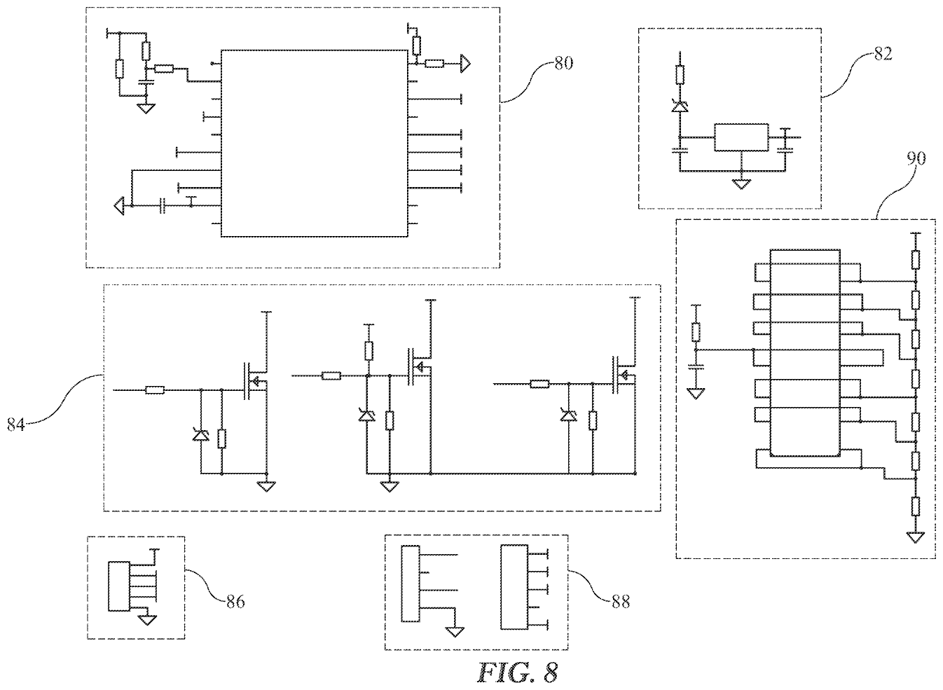

FIG. 8 depicts exemplary control circuitry for performing aspects disclosed herein. The control circuitry depicted in FIG. 8 includes a main microcontroller unit 80, a voltage regulator 82, a modulator 84, a programming header 86, board connections 88, and a CCT adjustment circuit 90.

The main microcontroller unit 80 may process various signals, including signals from a dimmer switch and a CCT controller, as well as signals from other circuitry, such as voltage regulator 82, modulator 84, programming header 86, and CCT adjustment circuity 90. In some implementations, main microcontroller 80 may take the form of one or more IC chips or processors.

Voltage regulator 82 regulates voltage supplied to components described herein, including e.g., CCT controllers. Voltage regulator 82 may create and maintain a steady output voltage, irrespective of input voltage or load conditions. Inclusion of voltage regulator 82 may enable consistent transmission of signals and operation of components discussed herein.

Modulator 84 varies one or more properties of signals transmitted throughout circuitry discussed herein. For example, modulator 84 may vary properties (e.g., voltage, current, frequency, etc.) of a dimmer switch signal having, e.g., a traditional 120 vac at 60 Hz and a given current, to having a modulated voltage, current, and/or frequency. In some implementations, modulation of properties input to modulator 84 may be based on components discussed herein, e.g., signals from a CCT controller or dimmer switch.

Programmable header 86 may facilitate loading or modification of software associated with the control circuit depicted in FIG. 7. Board connections 88 may facilitate communication between components discussed herein.

CCT adjustment circuitry 90 facilitates adjustment of CCT associated with a composite light emitted by one or more LEDs. CCT adjustment circuitry 90 may coordinate mixing of CCTs of subsets of LEDs of an LED bank, such that one or more subsets of LEDs having disparate CCT compositions taken singularly may emit light at each disparate CCT composition that mix to create a composite light corresponding to another CCT composition. CCT adjustment circuitry may drive subsets of LEDs corresponding to disparate CCTs at disparate brightness to result in a composite light, formed by a combination of all the subsets of LEDs emitting respective lights that mix together. In some implementations, CCT adjustment circuitry may or may not drive one or more subsets of LEDs to achieve a desired composite light.

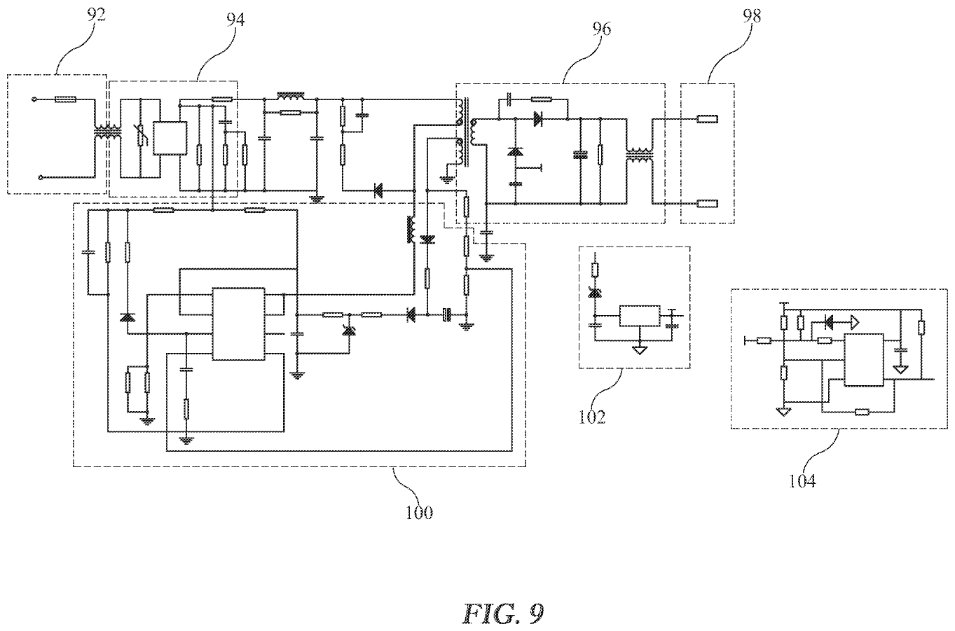

FIG. 9 depicts power circuitry for performing aspects disclosed herein. The power circuitry depicted in FIG. 9 includes leads for line voltage 92, a metal oxide varistor (MOV) for surge protection 94, a transformer 96, leads for one or more LEDs 98, a flyback controller 100, a voltage regulator 102, and a circuit for determining a dimmer switch position 104.

Line voltage 92 may be 120 VAC at a frequency of 60 Hz. Line voltage 92 may first pass through the MOV 94, which may prevent electrical surges from line voltage 92 from impacting the circuitry depicted in FIGS. 8 and 9. A transformer 96 may convert voltages for circuitry discussed herein. For example, transformer 96 may convert 120 VAC line voltage 92 to a voltage that may be more suitable for circuitry discussed herein, such as converting 120 VAC to 1-5 VDC, which is a more common voltage used to drive LEDs. A flyback controller 100 may also transform voltages for circuitry discussed herein. Voltage regulator 102 may ensure that circuitry discussed herein is provided a stable DC power. The circuit for determining a dimmer switch position 104 may provide output indicative of estimated current settings of a dimmer switch to circuitry discussed herein, enabling circuitry to be responsive to current settings and adjustments of a dimmer switch.

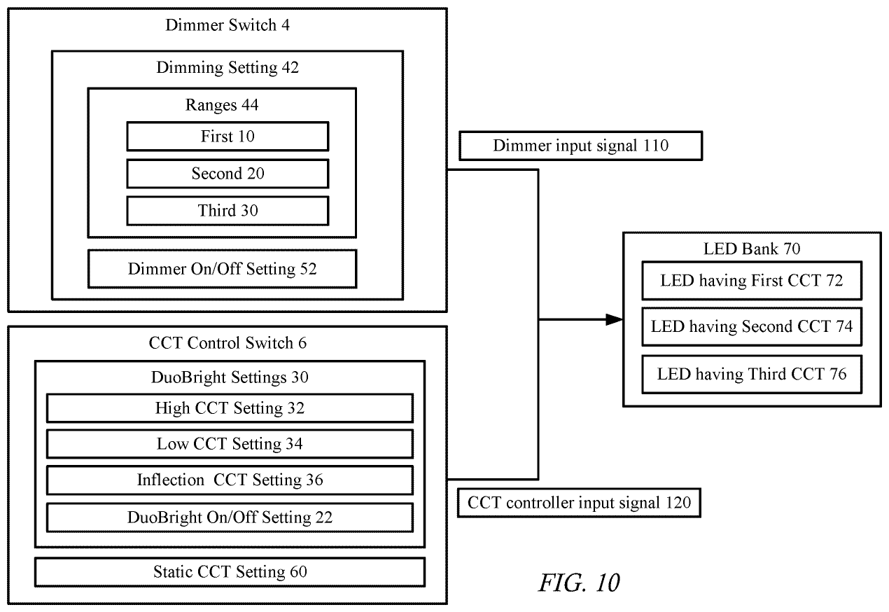

FIG. 10 depicts a block diagram of how components discussed herein may communicate with each other. Dimmer switch 4 may correspond with dimming settings 42, including ranges 44 and a dimmer on/off setting 52. Ranges 44 may include a first range 10, a second range 20, and a third range 30, which may correspond with e.g., a given position of dimmer switch 4. Dimmer input signal 110 corresponds with settings of dimmer switch 4, such as a current range 44 that a dimming setting 42 corresponds with and a On/Off setting 52 of dimmer switch 4. CCT controller 6 may correspond with dual bright settings 30, including high CCT setting 32, low CCT setting 34, inflection CCT setting 36, and a dual bright On/Off setting 22. CCT controller 6 may also correspond with static CCT setting 60, which as discussed may apply if dual bright On/Off setting 32 is “Off”. CCT controller input signal 120 correspond with settings of CCT controller 6, including dual bright settings 30 and static CCT settings 60. As depicted in FIG. 10, aspects of dimmer input signal 110 and CCT controller input signal 120 may combine to drive LED bank 70. LED bank 70 may include an LED having a first CCT 72, a LED having a second CCT 74, and a LED having a third CCT 76. The LEDs of LED bank 70 may be driven to emit a desired composite light, as discussed herein.

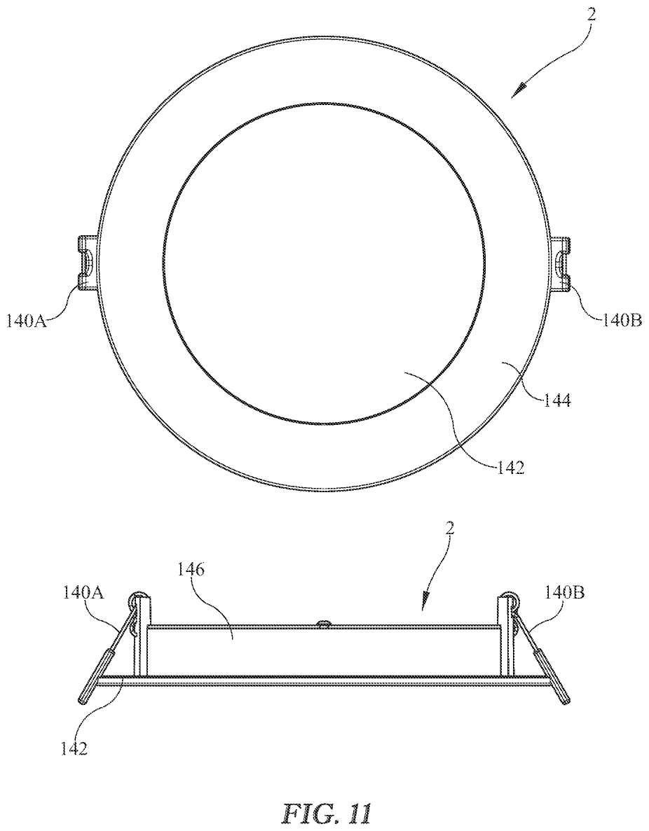

FIG. 11 depicts an example luminaire 2. Luminaire housing 2 may include a diffuser 142 for diffusing light emitted by LEDs. For example, diffuser 142 may diffuse a composite light emitted according to disclosure herein to impact brightness, CCT, and intensity of light emitted directly from LEDs. A flange 144 may surround diffuser 142 and provide structural integrity to luminaire housing 2. Retention springs 140A and 140B may cause luminaire housing 2 to be pulled adjacent to a structure, e.g., by one or more of retention springs 140A and/or 140B interfacing with a structure and exerting a spring force causing luminaire housing 2 to be pulled substantially closer to said structure. Luminaire 2 may also include housing 146, which may provide structural support, and which may house various components inside luminaire 2, including but not limited to LEDs and related circuitry.

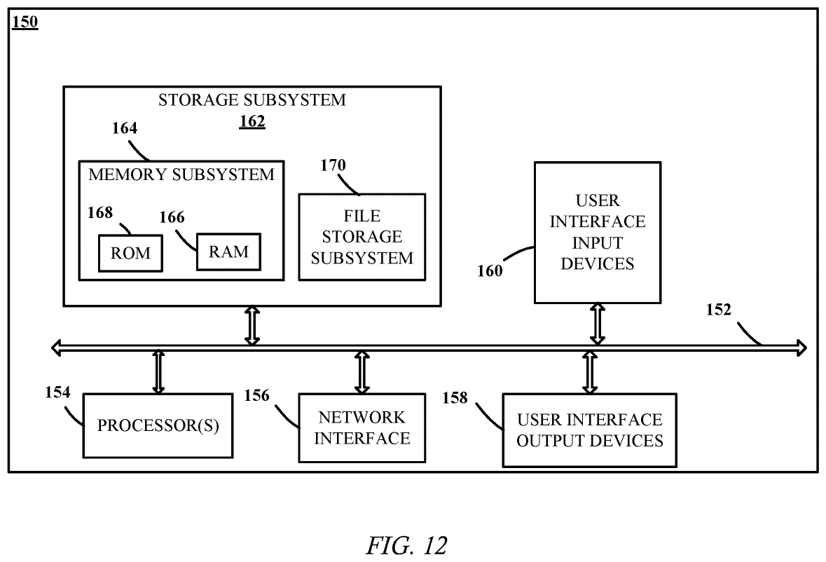

FIG. 12 is a block diagram of an example computing device 150 that may optionally be utilized to perform one or more aspects of techniques described herein. Computing device 150 typically includes at least one processor 154 which communicates with a number of peripheral devices via bus subsystem 152. These peripheral devices may include a storage subsystem 162, including, for example, a memory subsystem 164 and a file storage subsystem 170, user interface output devices 158, user interface input devices 160, and a network interface subsystem 156. The input and output devices allow user interaction with computing device 150. Network interface subsystem 156 provides an interface to outside networks and is coupled to corresponding interface devices in other computing devices.

User interface input devices 160 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 150 or onto a communication network.

User interface output devices 158 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 150 to the user or to another machine or computing device.

Storage subsystem 162 stores programming and data constructs that provide the functionality of some or all of the modules described herein. For example, the storage subsystem 162 may include the logic to perform selected aspects disclosed herein.

These software modules are generally executed by processor 154 alone or in combination with other processors. Memory 164 used in the storage subsystem 162 can include a number of memories including a main random-access memory (RAM) 166 for storage of instructions and data during program execution and a read only memory (ROM) 168 in which fixed instructions are stored. A file storage subsystem 170 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 170 in the storage subsystem 162, or in other machines accessible by the processor(s) 154.

Bus subsystem 152 provides a mechanism for letting the various components and subsystems of computing device 150 communicate with each other as intended. Although bus subsystem 152 is shown schematically as a single bus, alternative implementations of the bus subsystem may use multiple busses.

Computing device 150 can be of varying types including a workstation, server, computing cluster, blade server, server farm, or any other data processing system or computing device. Due to the ever-changing nature of computers and networks, the description of computing device 150 depicted in FIG. 12 is intended only as a specific example for purposes of illustrating some implementations. Many other configurations of computing device 150 are possible having more or fewer components than the computing device depicted in FIG. 12.

Accordingly, one or more of parameters, components, and circuits discussed herein may be controlled using a computing device having one or more features depicted in FIG. 12. For example, parameters including CCT, brightness, adjustment ratios, and ranges associated therewith may be controlled by computing device, e.g., a remote, phone, laptop, etc. Further, an application may execute on a device to enable said control. In some implementations, the device may control the aforementioned parameters using Bluetooth or Wifi protocols.

Examples disclosed herein are merely demonstrative of the numerous applications and variations that can be achieved.

It is to be understood that aspects disclosed herein are not limited in application to the details of construction and the arrangement of components set forth in the following description or illustrated in the drawings. The described embodiments are capable of other embodiments and of being practiced or of being carried out in various ways. That is, the structure of aspects disclosed herein is presented for purpose of illustration and description only. It is understood that numerous modifications and alterations of aspects disclosed herein may be made while retaining the teachings of the present disclosure. Consequently, the aspects disclosed herein may be installed in various environments. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to direct physical or mechanical connections or couplings. It should be understood that the aspects disclosed herein could vary greatly and still accomplish the same intent. The elements depicted in the accompanying figures may include additional components and that some of the components described in those figures may be removed and/or modified without departing from scopes of the elements disclosed herein. The elements depicted in the figures may not be drawn to scale and thus, the elements may have different sizes and/or configurations other than as shown in the figures.

1. An LED lamp for operation with a first input signal received from a dimmer switch and a second input signal received from a correlated color temperature (CCT) controller, the dimmer switch having a dimmable range of a first portion, a second portion, and a third portion, the second input signal associated with a high CCT setpoint, low CCT setpoint, and an inflection CCT setpoint, the first input signal corresponding to a setting of the dimmer switch and the second input signal corresponding to a setting of the CCT controller, comprising:
a first LED light source having a first CCT;
a second LED light source having a second CCT different from the first CCT;
a third LED light source having a third CCT different from the first CCT and the second CCT;
wherein first light emitted from the first LED light source, second light emitted from the second LED light source, and third light emitted from the third LED lights source, combine during operation to produce a composite light having a brightness and a composite CCT; and
control circuitry coupled with the first, second, and third LED light sources and configured to couple with the first input signal and the second input signal and drive the first, second, and third LED light sources based thereon, wherein the control circuitry is further configured to:
maintain the brightness of the composite light while changing the composite CCT from the high CCT setpoint to the inflection CCT setpoint responsive to changes of the setting of the dimmer switch that are within the first portion of the dimmable range until the composite CCT reaches the inflection CCT setpoint;
change the brightness of the composite light while also changing the composite CCT responsive to changes of the setting of the dimmer switch that are within the second portion of the dimmable range until the composite CCT reaches the low CCT setpoint; and
change the brightness of the composite light while maintaining the composite CCT at the low CCT setpoint responsive to changes of the setting of the dimmer switch that are within a third portion of the dimmable range.

2. The LED lamp of claim 1, wherein the setting of the CCT controller corresponds with an adjustable switch of the CCT controller.

3. The LED lamp of claim 2, wherein the setting of the dimmer switch corresponds with adjustment of the dimmer switch.

4. The LED lamp of claim 2, wherein each of the high CCT setpoint and the low CCT setpoint are independently adjustable using the adjustable switch or one or more other adjustable switches of the CCT controller.

5. The LED lamp of claim 1, wherein one or more of the control circuitry, the CCT controller, and the dimmer switch are controlled by a remote device.

6. The LED lamp of claim 5, wherein the remote device comprises a phone, computer, smart device, or third party remote.

7. The LED lamp of claim 5, wherein one or more of the control circuitry, the CCT controller, and the dimmer switch are controlled by an application executing on the remote device.

8. The LED lamp of claim 1, wherein the dimmer switch is a triac dimmer switch.

9. An LED lamp for operation with a first input signal received from a dimmer switch and a second input signal received from a correlated color temperature (CCT) controller, wherein the first input signal corresponds to a dimming setting of the dimmer switch, the dimming setting including a plurality of ranges, and wherein the second input signal corresponds to CCT controller settings associated with a high CCT setpoint, a low CCT setpoint, and an inflection CCT setpoint, wherein the high CCT setpoint and the low CCT setpoint are independently adjustable, the inflection CCT setpoint is defined by the high CCT setpoint and the low CCT setpoint, and the LED lamp includes:
LED light sources having distinct CCT ranges that emit light during operation to produce a composite light having a brightness and a composite CCT; and
control circuitry coupled with the LED light sources and configured to couple the first input signal and the second input signal and drive the LED light sources based thereon, wherein the control circuitry is further configured to:
maintain the brightness of the composite light while changing the composite CCT from the high CCT to the inflection CCT responsive to changes of the setting of the dimmer switch that are within a first range until the composite CCT reaches the inflection CCT;
change the brightness of the composite light while also changing the composite CCT responsive to changes of the setting of the dimmer switch that are within a second range until the composite CCT reaches the low CCT; and
change the brightness of the composite light while maintaining the composite CCT at the low CCT responsive to changes of the setting of the dimmer switch that are within a third range.

10. The LED lamp of claim 9, wherein the setting of the CCT controller corresponds with an adjustable switch of the CCT controller.

11. The LED lamp of claim 10, wherein the setting of the dimmer switch corresponds with adjustment of the dimmer switch.

12. The LED lamp of claim 10, wherein each of the high CCT setpoint and the low CCT setpoint are independently adjustable using the adjustable switch or one or more other adjustable switches of the CCT controller.

13. The LED lamp of claim 9, wherein one or more of the control circuitry, the CCT controller, and the dimmer switch are controlled by a remote device.

14. The LED lamp of claim 13, wherein the remote device comprises a phone, computer, smart device, or third party remote.

15. The LED lamp of claim 13, wherein one or more of the control circuitry, the CCT controller, and the dimmer switch are controlled by an application executing on the remote device.

16. The LED lamp of claim 1, wherein the dimmer switch is a triac dimmer switch.

17. An LED lamp for operation with a first input signal corresponding to a dimming setting of a dimmer switch and a second input signal corresponding to a CCT controller setting that is associated with a high CCT setpoint, a low CCT setpoint, and an inflection CCT setpoint, wherein one or more of the high CCT setpoint, the low CCT setpoint, and the inflection CCT setpoint are adjustable by one or more switches of the CCT controller;
the LED lamp including a bank of LEDs emitting light during operation to produce a composite light having a brightness and a composite CCT within a range of CCT defined by the high CCT setpoint and the low CCT setpoint, and control circuitry coupled with a bank of LEDs,
wherein the control circuitry is configured to couple the first and second input signal and drive the bank of LEDs at the brightness and the composite CCT based on the first input signal and the second input signal, and adjust both brightness and composite CCT within the range of CCT based on the dimming setting corresponding to an inflection point CCT setting.

18. The LED lamp of claim 17, wherein one or more of the control circuitry, the CCT controller, and the dimmer switch are controlled by a remote device.

19. The LED lamp of claim 18, wherein the remote device comprises a phone, computer, smart device, or third party remote.

20. The LED lamp of claim 18, wherein one or more of the control circuitry, the CCT controller, and the dimmer switch are controlled by an application executing on the remote device.
